(19) United States
(12) Patent Application Publication
(10) Pub. No.: US 2023/0233885 A1
(43) Pub. Date: Jul. 27, 2023

(54) SOUND ATTENUATING MASK

(71) Applicant: RESMED PTY LTD, Bella Vista (AU)

(72) Inventors: Lachlan Richard GOLDSPINK, Sydney (AU); Matthew EVES, Sydney (AU); Hugh Francis Stewart THOMAS, Sydney (AU); Lorenz EBERL, Sydney (AU); Gaetano CALDAROLA, Sydney (AU)

(21) Appl. No.: 18/099,836

(22) Filed: Jan. 20, 2023

(30) Foreign Application Priority Data
Jan. 21, 2022 (AU) 2022900117

(51) Int. Cl. A62B 18/08; A41D 13/11; A62B 18/02

(52) U.S. Cl. CPC A62B 18/08; A41D 13/1107; A62B 18/025

(57) ABSTRACT

A mask for interfacing with a user's face to reduce audible noise in a user's surroundings resulting from a user's voice. In some forms disclosed is a mask including a sound attenuating structure. In some forms the mask is also transparent or partially transparent to allow a view of the user's face.

### TECHNICAL FIELD

The disclosure relates to a face mask with sound attenuating properties. The disclosure is generally described in relation to masks for use with a mobile telecommunications device but can be used in any circumstance where there is benefit to limiting sound into and out of a mask.

### BACKGROUND ART

It is to be understood that, if any prior art is referred to herein, such reference does not constitute an admission that the prior art forms a part of the common general knowledge in the art, in Australia or any other country.

Society has long felt a need for sound attenuation, limitation of transmission of voice, and privacy enhancement in use of mobile devices and similar systems. The COVID-19 pandemic has further revolutionised standard workplace requirements for businesses across the world. With all businesses integrating some form of remote working arrangements, the ability to converse via remote video-calls online via platforms such as Zoom and/or Microsoft teams has become the norm. On top of this added workflow mechanic, the COVID-19 pandemic has also made the use of masks for health and safety reasons a standard requirement for when working in an office environment and/or public setting.

A common problem that workers experience while working in their office and/or home environment is lacking the ability to privately take work-related calls without the danger of every word being heard. In addition, calls need to be taken without interruption. Limiting listeners along with external noise factors such as children, roommates, pets and/or other colleagues have become added challenges to the workplace experience. There has now been a market demand for a comfortable and private technological solution for use in public and/or in the office that allow one privately take part in work-related calls. In addition, it can be useful to be able to convey facial expressions behind a mask.

Known market solutions lack aesthetic appeal and the functional capacity which the everyday worker needs. Thus, the combined need to wear a COVID-19 safe mask in tandem with taking part in work-related calls privately have created a unique market demand

### SUMMARY

Disclosed herein is a mask for interfacing with a user's face to reduce audible noise in a user's surroundings resulting from a user's voice. In some forms disclosed is a mask including a sound attenuating structure. In some forms the mask is also transparent or partially transparent to allow a view of the user's face.

The mask may have the benefits of providing for protection, privacy or lack of broadcast of telecommunications when in public, whether in an office or other environment. In addition, in some forms the mask may allow for video conferencing to be held without everybody in the surrounds hearing the users voice, but maintaining the ability for the conference attenders to see the user's face. In addition in some forms the mask may allow for an aesthetically pleasing and comfortable sound attenuating mask for protection and privacy.

An aspect of the present disclosure relates to a mask including an interfacing structure configured to interface with the user's face and a sound attenuating structure to limit sound emanating from the user's voice.

In some embodiments, the interfacing structure may comprise a mouth interface configured to interface with the user's face around the user's mouth.

In some embodiments, the interfacing structure may comprise a mouth interface and a nose interface, configured to interface with the user's face around the user's nose and mouth.

In some embodiments, the nose interface may be configured to interface with at least a portion of the user's nares, inferior to the user's nasal ridge.

In some embodiments, the nose interface may be configured to interface with at least a portion of the user's nasal ridge, superior to the user's nares.

In some embodiments, the interfacing structure may form a seal with the user's face.

In some embodiments, the body may comprise an outer shell structure.

In some embodiments the outer shell structure may form a three-dimensional shaped chamber that may be located around a user's mouth.

In some embodiments, the outer shell structure may comprise an outer shell and an inner shell, wherein the outer shell structure is spaced apart from the user's face.

In some embodiments, a vacuum cavity may be located between the outer shell and the inner shell, the vacuum cavity being defined by a seal formed between the inner shell and outer shell.

In some embodiments, a plurality of pillars may be arranged in a spaced relationship between the inner shell and the outer shell and across the vacuum cavity.

In some embodiments, the inner shell of the outer shell structure may interface with the sound attenuating structure.

In some embodiments, the outer shell structure may be formed from acrylic or an acrylic-like material.

In some embodiments, the outer shell structure may comprise a valve that allows for air inhalation, exhalation and sound attenuation.

In some embodiments, the valve may be made from silicone or a silicone-like material. In some forms, the valve may function as an anti-asphyxia valve by allowing the user to breathe in fresh air from their surroundings, rather than re-breathing the same air within the mask.

In some embodiments, the outer shell structure may be at least partially transparent when viewed from the outside.

In some embodiments, at least a portion of the sound attenuating structure may be positioned between the outer shell structure and the interfacing structure.

In some embodiments, the sound attenuating structure may comprise an inner layer and outer layer, wherein at least a portion of the inner layer interfaces with the interfacing structure.

In some embodiments, the sound attenuating structure may reduce movement of sound into and out of the mask while allowing movement of air into and out of the mask.

In some embodiments, the outer layer of the sound attenuating structure may act as a controlled path for airflow and to attenuate sound.

In some embodiments, the three-dimensional chamber of the body may be defined by at least a portion of the interfacing structure and one or both the sound attenuating structure and the outer shell structure.

In some embodiments, the sound attenuating structure may be integral with the interfacing structure.

In some embodiments, the interfacing structure may be arranged within the cavity of the body and act as a controlled path to attenuate sound.

In some embodiments, the mask may comprise a positioning and stabilising structure providing a force to secure the body of the mask in position on the user's face.

In some embodiments, the positioning and stabilising structure may comprise a strap.

In some embodiments, the strap may be made from a fabric-like material with elastic sections.

In some embodiments, the sound attenuating structure may comprise a ventilation structure, the ventilation structure comprising a fan mechanism and a filter structure.

In some embodiments, the outer shell structure may be double glazed.

In some embodiments, the outer shell structure may comprise a tube protruding externally from the outer shell of the outer shell structure.

In some embodiments, the sound attenuating structure may be made from a foam-like material with suitable sound attenuating properties.

A mask as defined in any of the preceding claims, the interfacing structure may be made from a foam-like material with acoustic deadening properties suitable for sound absorption, while providing comfort to the user. In some forms, there may be added compliance to the interface that is formed with the user's face.

In some embodiments, the mask may further comprise a mask cover.

In some forms, the mask cover may be attached to the mask via a Velcro mechanism and/or button mechanism.

In some embodiments, the outer shell structure may be non-rigid.

In some forms, the mask may provide sound attenuating properties with a non-rigid, pliable and/or flexible outer shell structure that is at least partially transparent when viewed from the outside.

In some forms, the mask may advantageously provide the user with sound attenuation properties by reducing the audible noise that is received into and/or emitted out of the mask. The mask may have the added benefit of reducing the audible noise received by a mobile device (which may be connected via wireless connection standards such as Bluetooth and/or Wi-Fi) from the user's surroundings, while capturing the user's voice.

In some forms, the mask may also provide at least some level of transparency, wherein at least a portion of the user's face (e.g. the user's mouth) may be visible when viewed from outside. This may advantageously allow others who are interacting with the user to know if and/or when the user is speaking.

In some forms the mask may be made from a material/s with the desired mechanical and aesthetic properties for its use-application. For example, the outer shell structure of the mask may be made from a material/s suitable for withstanding and protecting the user from external environmental factors. In other examples, the outer shell structure of the mask may be made from a non-rigid, flexible and/or pliable material/s that may advantageously provide a level of comfort while also providing the desired mechanical properties for when the mask is in use.

### BRIEF DESCRIPTION OF THE DRAWINGS

Embodiments will now be described by way of example only, with reference to the accompanying drawings in which

FIG. 1 is an isometric view of a mask of an embodiment of the disclosure;

FIG. 2 shows an isometric view of a mask of an embodiment of the disclosure in use;

FIG. 3 is an exploded view of a body of a mask of an embodiment of the disclosure;

FIG. 4A is a longitudinal cross-sectional view of the body of a mask of FIG. 3;

FIG. 4B is a lateral cross-section of the sound attenuating structure of the mask of FIG. 3;

FIG. 5A is an isometric view of the wall of the outer shell structure of one embodiment of the disclosure

FIG. 5B is a cross-sectional view of the wall of the outer shell structure of FIG. 5A;

FIG. 6 shows the mask of FIG. 4 in use;

FIG. 7a is an isometric view of a mask of one embodiment of the disclosure;

FIG. 7b is an exploded view an exhaust structure of a mask of one embodiment of the disclosure;

FIG. 8 is a cross sectional view of a mask of an embodiment of the disclosure in use;

FIG. 9 is a cross sectional view of a mask of an embodiment of the disclosure in use;

FIG. 10 is a cross sectional representation of a section of a mask of one embodiment of the disclosure;

FIG. 11 is an exploded view of a section of a mask of one embodiment of the disclosure;

FIG. 12 is a front view of a mask of one embodiment of the disclosure;

FIG. 13 is a rear view of the mask of FIG. 12;

FIG. 14 is a side view of a mask of one embodiment of the disclosure in use;

FIG. 15 is a side of a mask of one embodiment of the disclosure in use;

### DETAILED DESCRIPTION

In the following detailed description, reference is made to accompanying drawings which form a part of the detailed description. The illustrative embodiments described in the detailed description, depicted in the drawings and defined in the claims, are not intended to be limiting. Other embodiments may be utilised and other changes may be made without departing from the spirit or scope of the subject matter presented. It will be readily understood that the aspects of the present disclosure, as generally described herein and illustrated in the drawings can be arranged, substituted, combined, separated and designed in a wide variety of different configurations, all of which are contemplated in this disclosure.

In the examples illustrated herein, the mask 1000 interfaces with the user's face. In some forms the mask is designed to reduce audible noise into and out of the mask. This may have the benefit of reducing audible noise received by a mobile device (which may be connected using known wireless connection standards/protocols such as via Bluetooth and/or Wi-Fi) from the user's surroundings rather than from the user's mouth. In addition, this may have the benefit of reducing audible noise emanating from the mask into the user's external environment. In some forms, the mask is designed to reduce or re-direct the noise emanating into the environment/surroundings from the user's voice thus increasing privacy of the conversation. In some forms the mask provides privacy from audible sound while allowing line of sight viewing of the mouth of the user when viewed from the outside. In some forms the mask provides comfortable privacy for a user.

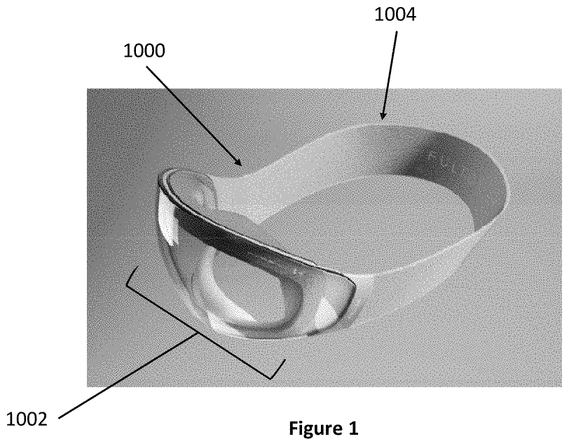

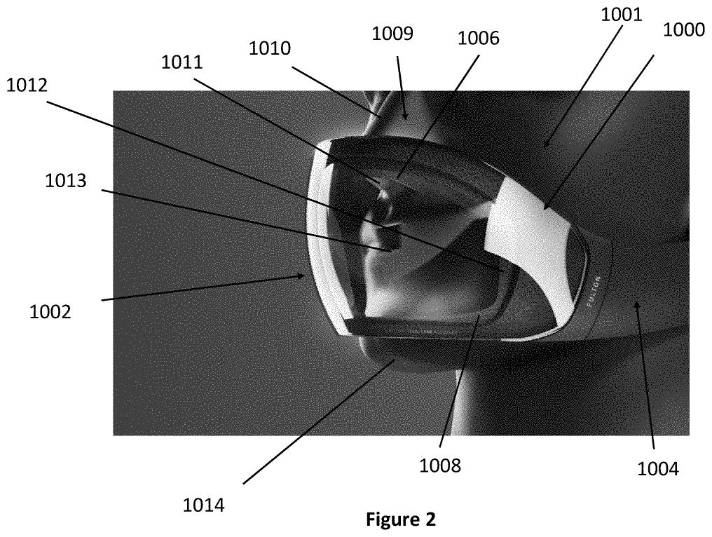

Referring first to FIGS. 1 and 2, disclosed is a mask designed for positioning against a user's face to limit audible sound entering or leaving the mask. In the illustrated form, the mask 1000 includes a body 1002 that is attached to a positioning and stabilising structure 1004. The body 1002 is configured to be positioned on a user's face to cover a portion of the face such as the mouth or nose and mouth. The position and features of the mask are adapted to allow attenuation, redirection or limiting of sound leaving from the user's mask and into the user's external environment such that sound emitted from the user, such as conversation, is reduced or eliminated in the environment outside the mask.

The positioning and stabilising structure 1004 in the illustrated form provides the required force to secure the body 1002 of the mask 1000 in position on the user's face 1001. In the illustrated form the positioning and stabilising structure 1004 is in the form of a strap which may be composed of a stretchable material. In other forms the strap may be in the form of multiple straps or hooks or any form that may secure the body of the mask to the face. In some forms, the strap may be adjustable to suit the user's head size and/or shape. When in position on the user's face, the mask 1000 may facilitate the functions of sound attenuation and hygiene/environmental safety, of which the mechanisms will be discussed further in later examples/embodiments.

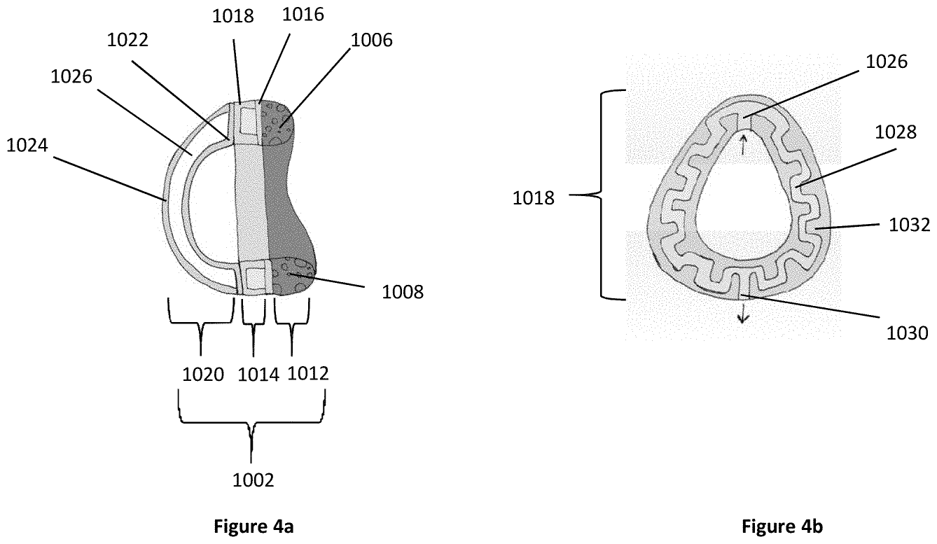

FIG. 2 illustrates an example of the mask 1000 from FIG. 1 in use where the body 1002 comprises an interfacing structure 1012 that is configured to allow the mask to interface with a user's face and/or act as a surface that makes contact with the user's face 1001. In some forms, the nose interface 1006 of the interfacing structure 1012 may be configured to interface on at least a portion around the user's nose 1009, and the mouth interface 1008 of the interfacing structure 1012 may be configured to interface with at least a portion around the user's mouth 1013. In some forms, as illustrated in FIG. 4, the nose interface 1006 may interface with at least a portion of the user's nares 1011 inferior to the user's nasal ridge 1010. Connected to the nose interface 1006, at least a portion of the mouth interface 1008 may interface inferior to the user's mouth 1013 and superior to the user's chin 1014. In some forms, the interfacing structure 1012 may be made from a material/s with acoustic deadening properties suitable for sound absorption while providing comfort for the user, such as memory foam and/or alternative materials. In some forms, there may be added compliance to the interface that is formed with the user's face 1001, as this may be particularly important for the mouth interface 1008 of the interfacing structure 1012 as there may be movement from the user's mouth while they are speaking. The interfacing structure 1012 may include a layer of memory foam cushion to provide a better fit for a wider range of facial geometries. The material of the interfacing structure 1012 may provide compensation for the dynamic motion of the user's jaw and/or face. In some forms, the interfacing structure 1012 may form a seal around at least a portion of the user's face 1001 and may act as an acoustic seal by further attenuating the sound emitted by the user into the user's external environment. The seal formed by the interfacing structure 1012 may advantageously prevent the inflow or exhaust of unwanted air or other particles and/or sound coming from user's external environment.

As illustrated in FIG. 2, the body 1002 of the mask 1000 may be secured onto the user's face through the force provided by the positioning and stabilising structure 1004. In some forms, the positioning and stabilising structure 1004 may be in the form of a single under-ear head-strap. The under-ear head strap would aim to provide a secure and comfortable fit and may be compatible with other head mounted devices or eyewear. In some forms the positioning and stabilising structure 1004 may be a single fabric strap with added elastic sections for comfort. In other forms the positioning and stabilising structure may be in the form of a different strap, multiple strap, or loops.

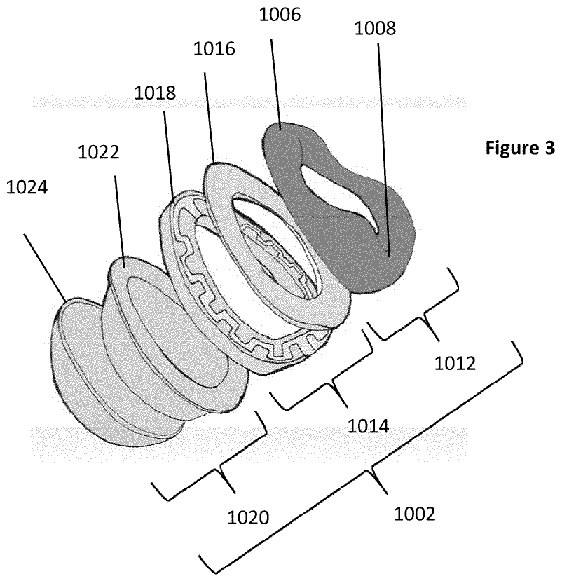

FIG. 3 is an exploded isometric view showing an embodiment of a body 1002 of a mask 1000. The body 1002 in this illustrated form comprises an interfacing structure 1012, a sound attenuating structure 1014 and an outer shell structure 1020. The body forms a three-dimensional chamber defined by the outer shell structure 1020 along with the interfacing structure 1012 and in some forms the sound attenuating structure 1014. The layers of the body 1002 in the illustrated form are sealed together to form the body 1002 or may be affixed without sealing in such a way as to be air-proof or to limit the movement of air emitted into and/or from the user's external environment. In this illustrated form the body 1002 is designed to allow air in to and out of the chamber while limiting transmission of sound out of the chamber or into the chamber. In some forms, the mask 1000 is at least partially transparent to allow a line of sight from the outside to at least a portion of the user's face.

In the illustrated form, the interfacing structure 1012 includes a mouth interface 1008 configured to form at least a portion of an interface around the user's mouth and a nose interface 1006 configured to form at least a portion of an interface around the user's nose. The nose interface 1006 may be connected to the mouth interface 1008 to define an overall interfacing structure 1012 that is configured to extend around a user's mouth and nose. The interfacing structure may be composed of a flexible or moldable material that can be shaped to form a comfortable interface with the user's face.

In some forms, the sound attenuating structure 1014 is a layer of the mask configured to reduce or redirect sound emanating from the user's mouth and to allow airflow in and out of the user's mask. The sound attenuating structure in the illustrated form includes an inner layer 1016 and an outer layer 1018. In some forms the sound attenuating and/or the interfacing structure 1014 may create a “sound maze” to reduce transmission of sound beyond the mask. At least a portion of the sound attenuating structure 1014 may be positioned between the outer shell structure 1020 and interfacing structure 1012.

In some forms, the outer shell structure 1020 may include an outer shell 1024 and inner shell 1022 that together may be spaced apart from the user's face by the three-dimensional chamber. In some forms the inner shell 1022 and outer shell 1024 may include a vacuum therebetween. In some forms, the vacuum or void may be sufficiently sealed for reducing or limiting transfer of sound energy between the inner shell 1022 and outer shell 1024 layers . In some forms the inner shell may interface with the outer layer 1018 of the sound attenuating structure 1014.

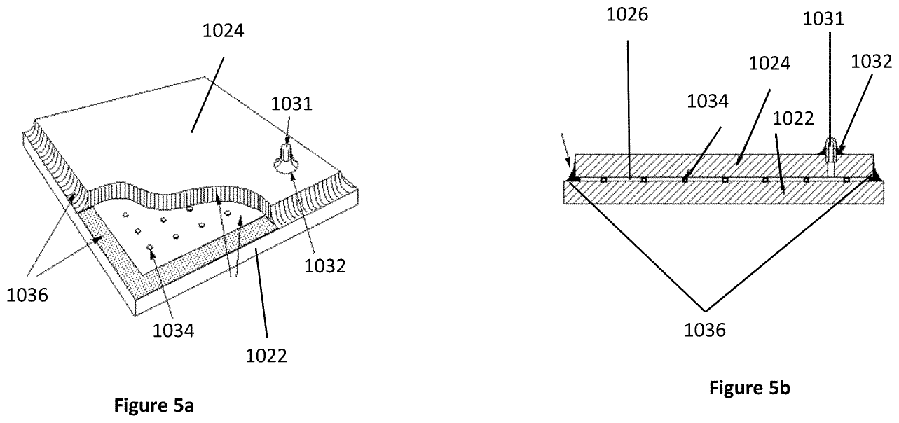

Referring now to FIGS. 4a and 4b, FIG. 4a illustrates a cross-sectional representation of the body 1002 from FIG. 3 in its enclosed form. As shown in FIG. 4a, at least a portion of the interfacing structure 1012 and one or both of the sound attenuating structure 1014 and outer shell structure 1020 may define the three-dimensional shaped chamber of the body 1002. In some forms, at least a portion of the inner layer 1016 of the sound attenuating structure 1014 may interface with the interfacing structure 1012. In some forms, the inner shell 1022 and outer shell 1024 of the outer shell structure 1020 may house a vacuum cavity 1026 that is defined by a seal formed between the inner shell 1022 and outer shell 1024 (better illustrated as 1036 in FIGS. 5a and 5b).

In some forms, the body may be shaped so that at least a portion of the interior surface of the body 1002 is not in contact with the user's face. For example, the body may be generally ovaloid with a positive dome shape with respect to the user's face. In other forms the body or may include multiple peaks to best form the profile of a user's face without coming into contact with the face. In some forms the body may have a D-shape with a generally straight lower edge running along the jaw and a curved upper edge running over the nose. In some forms the body has a curved outer surface and curved inner surface that follow the general profile of the lower part of the face. In some forms only the interfacing structure is in contact with the face. In some forms the interfacing structure meets the face at the cheeks, chin and nose, while in other forms the interfacing structure meets the face at the jawline or close to the ears.

In some forms the outer shell structure may be made from a material suitable for withstanding and protecting the user from external environmental factors. In some forms the material may be acrylic and/or other material/s with similar mechanical and/or aesthetic qualities. In some forms, the outer shell structure 1020 may be made from a non-rigid, flexible and/or pliable material/s depending on the desired mechanical and/or aesthetic characteristics for the mask 1000 when in use.

FIG. 4b illustrates a front view representation of an example of the outer layer 1018 of the sound attenuating structure 1014 from FIGS. 3 and 4a. In some forms, the outer layer 1018 may be contoured in a maze-like structure by its walls 1032 and may serve as a controlled path that attenuates sound emitted from the user's voice. In some forms the maze structure or controlled path may be a tortuous or winding path. In some forms the path may comprise a path with multiple square or near square turns where the path turns around itself. In some forms the path includes multiple approximate right angle turns.

In use, the sound emitted from user's voice may enter the sound attenuating structure through the inlet 1026 of the contoured pathway 1028 defined by the walls 1032 and exit through the outlet 1030 in its attenuated form. In some forms sound transmitted into the maze reflects from faces as the sound proceeds through the maze. In some forms the maze may have a path designed to mute or decrease transmission of sound. In some forms, the outer layer 1018 of the sound attenuating structure 1014 may be made from a material with suitable sound attenuating properties, such as foam.

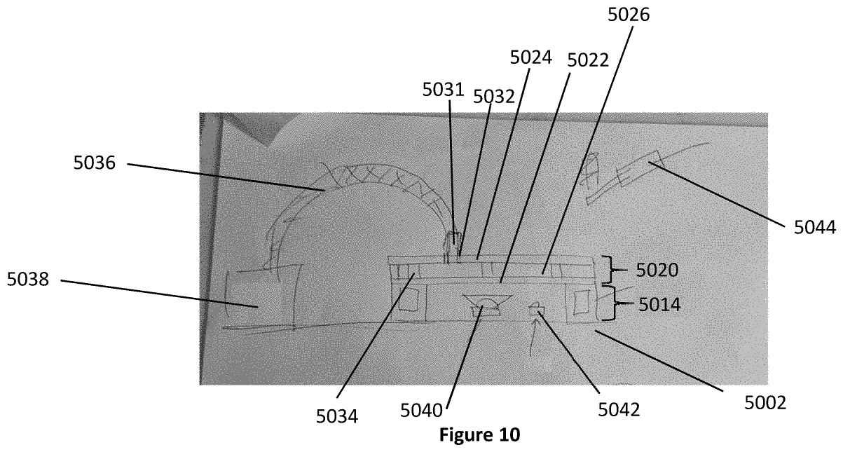

FIGS. 5a and 5b respectively illustrate an isometric and cross-sectional schematic of the structure of the outer shell structure 1020. In the illustrated embodiment the outer shell is separated from the inner shell 1022 and the edges of outer shell 1024 and inner shell 1022 may be soldered together to form an edge seal 1036. A vacuum cavity 1026 is defined between the outer shell and the inner shell by the seal 1036. Across this vacuum cavity 1026, a plurality of pillars 1034 may be arranged in a spaced relationship between both the outer shell 1024 and inner shell 1022. A stub of a pump-out tube 1031 may be soldered into and protrude from the outer shell layer 1024 to together form a seal 1032. The tube 1031 may act as an outlet that connects to a vacuum pump via a pipe (better illustrated in FIG. 10 as 5038 and 5036 respectively) to create a vacuum cavity that allows for better sound attenuation within the mask.

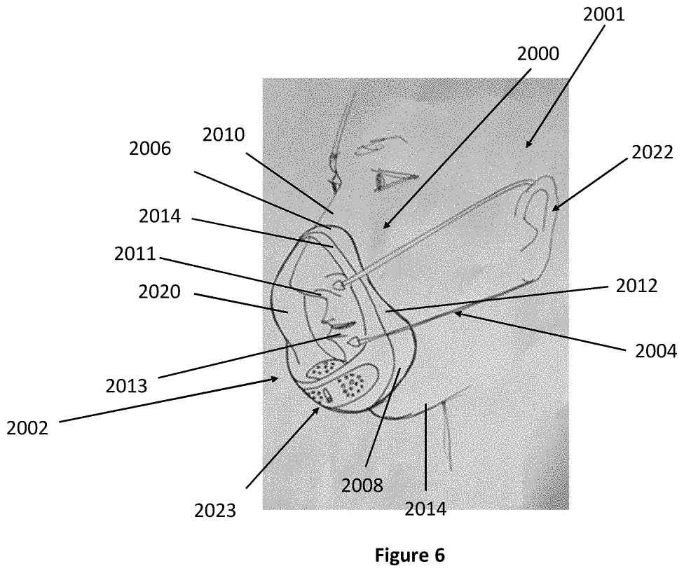

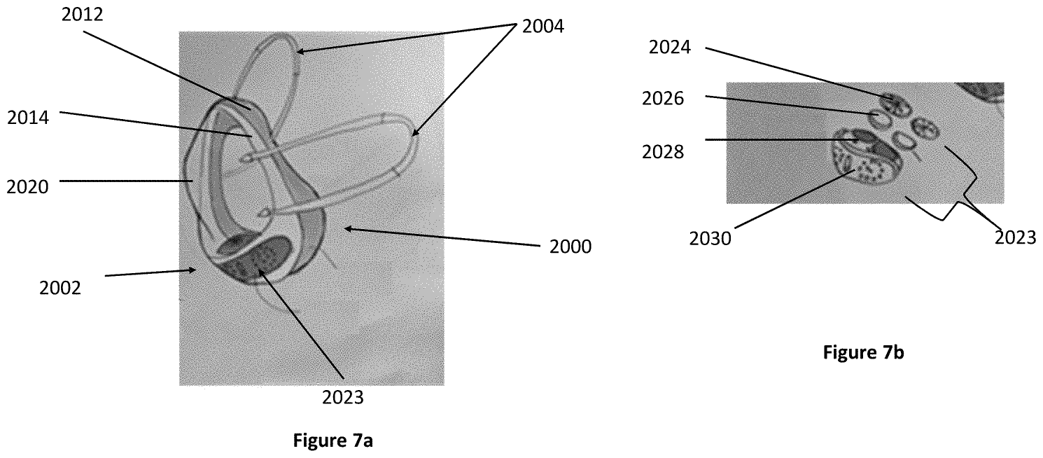

Referring now to FIG. 6, disclosed is a further embodiment of the mask 2000 wherein the positioning and stabilising structure 2004 is configured to wrap around the user's ears 2022 to secure the body 2002 with respect to the user's face 2001. In this embodiment, the nose interface 2006 of the interfacing structure 2012 may interface with at least a portion of the nasal ridge 2010 superior to the nares 2011, and the connected mouth interface 2008 extending from the nose interface 2006 may interface around the lower edge of the user's mouth 2013. In this embodiment, the body houses a ventilation structure 2023, which is further illustrated in FIG. 7b.

Referring now to FIGS. 7a and 7b, the embodiment from FIG. 6 is illustrated in FIG. 7a, with FIG. 7b illustrating an exploded view representation of the ventilation structure 2023. Referring now to FIG. 7b, the ventilation structure 2023 may include a fan mechanism 2024, a filter structure 2026 and a power source 2028 that are together compartmentalised in a housing structure 2030. This ventilation structure 2023 is particularly advantageous as it may help the user with breathing while filtering the air particles that come in and out of the body 2002 of the mask 2000. In some forms, the ventilation structure 2023 may assist with both the inflow and outflow of air and/or the user's breath while in use. In some forms, the filter structure 2026 of the ventilation structure 2023 may function by filtering any unwanted air-borne diseases/pathogens through known air filtration methods, such as using specialised anti-bacterial coating and/or airborne particle size filtration (for example, compliant with N95 respirator standards). Furthermore, the ventilation structure 2023 may assist with dehumidifying the interior cavity of the body 2002 and keeping the outer shell structure 2020 transparent when viewed through by an external viewer.

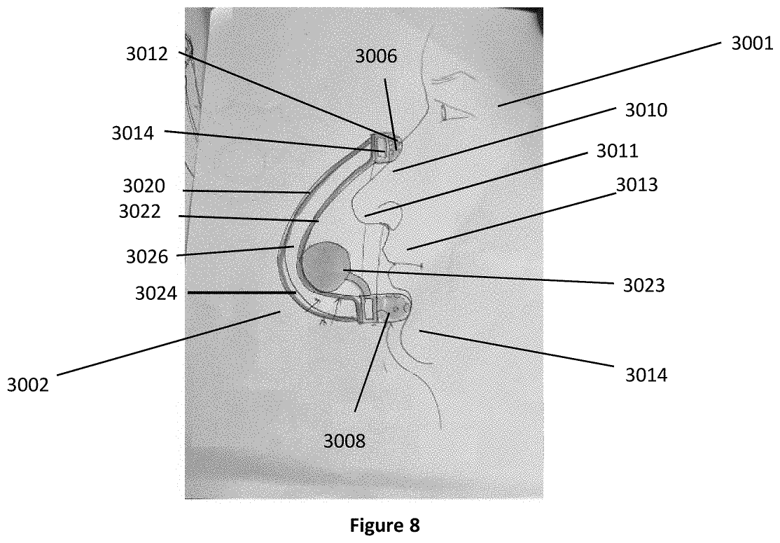

FIG. 8 illustrates an example of a further embodiment of the disclosure with a cross sectional representation of a body 3002 of a mask interfacing with the user's face 3001. In this illustrated form the nose interface 3006 of the interfacing structure 3012 forms an interface with the nasal ridge 3010 while the mouth interface 3008 of the interfacing structure 3012 forms an interface between the user's mouth 3013 and chin 3014. In some forms, the ventilation structure 3023 (previously illustrated as 2023 in FIGS. 6-7) may be housed within the body 3002 adjacent to the inner shell 3022 of outer shell structure 3020. In some forms, the fan mechanism 3024 (not visible) of the ventilation structure 3023 may direct air and sound within the cavity of the body 3002 into the inlet of the sound attenuating structure 3014. The sound attenuating structure 3014 may then control the flow of air and attenuate sound emitted from the user's voice, as per the description of the outer layer 1018 of the sound attenuating structure 1014 in FIG. 4b.

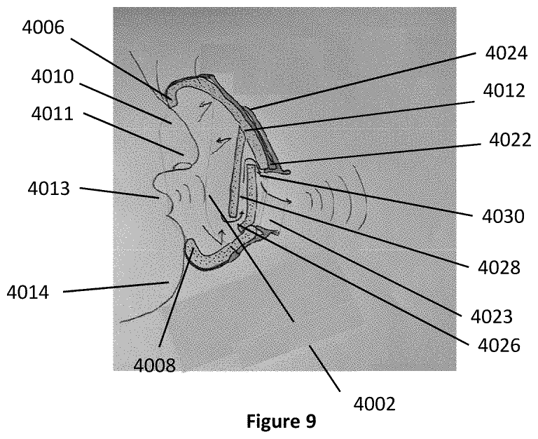

FIG. 9 illustrates a mask of a further embodiment of the disclosure 4000 wherein the interfacing structure 4012 is integral with or associated with the sound attenuating structure 4014. As illustrated in FIG. 9, the interfacing structure 4012 may be built against the interior walls of the mask's body 4002. The nose interface 4006 and mouth interface 4008 may form an interface around both the user's nose 4009 and mouth 4013 to form an enclosed environment in which the user may project their voice and breath. In some forms, the interfacing structure 4012 may be arranged within the cavity of the body 4002 to act as a controlled path for air to escape and to attenuate sound emitted from the user's voice. The sound and air emitted from the user may enter through the inlet 4026 through the controlled pathway 4028 and escape through the outlet 4030. In some forms, a ventilation structure 4023 may be included with the outer shell structure 4020 and may assist with redirecting the air and sound escaping through the outlet 4030. In some forms, the interfacing structure 4012 may be integral with the sound attenuating structure 4014 and may be made of materials with sound deadening properties as previously discussed, such as foam. In some forms the controlled path of sound allows for reflection of sound back toward the wearer such that the sound may actively be reduced.

FIG. 10 illustrates a cross-sectional schematic representation of the vacuum cavity 5026 housed within the outer shell structure 5020 previously illustrated in FIGS. 5a and 5b. A pump-out tube 5031 may be soldered into the outer layer 5024 of the outer shell structure 5020 and form a seal 5032. A pipe 5036 may connect the pump-out tube 5031 to an external vacuum pump 5038 to create a vacuum cavity 5026 within the outer shell structure 5020. In some forms, the vacuum cavity 5026 may attenuate the sound of the user's voice that is represented as a sound source 5040 that is picked up via a built-in microphone 5042. The built-in microphone 5042 housed within the body 5002 may assist with capturing the user's voice 5040 even in a noisy external environment with the added assistance of an external microphone 5044. In some forms, the external microphone 5044 may allow the mask to provide an active-noise cancellation function by capturing the external ambient noise from the user's external environment. In some forms, the external microphone 5044 may assist the user with listening to their own voice if they, for example, do not have headphones that are coupled to the built-in microphone 5042. In some forms the external microphone 5044 may assist the built-in microphone 5042 in allowing third-party external viewers to hear the user's voice while in use.

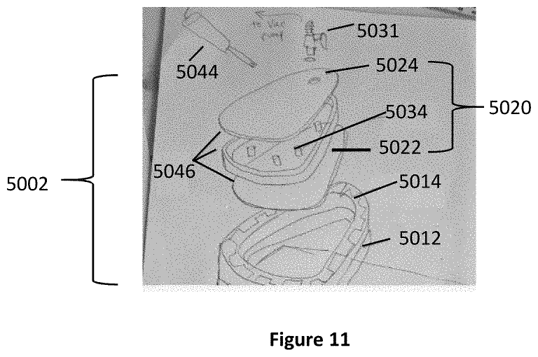

FIG. 11 illustrates an exploded view representation of the components of the mask's body 5002 similar to the disclosure of FIG. 10. As per previous embodiments, the body 5002 may include an interfacing structure 5012, sound attenuating structure 5014 and outer shell structure 5020. Within the outer shell structure 5020 it may include an inner shell 5022, outer shell 5024 and pillars 5034 evenly spaced in between. The components of the outer shell structure 5020 may adhere to one another through the use of a silicone or urethane-based adhesive 5046. A tube 5031 may protrude externally from the outer shell 5024 of the outer shell structure 5020 to be connected externally to a vacuum pump (not visible). An external microphone 5044 may also be attached to the mask's body 5002 to assist with the mask in providing active noise cancellation and other functions as per the description for FIG. 10.

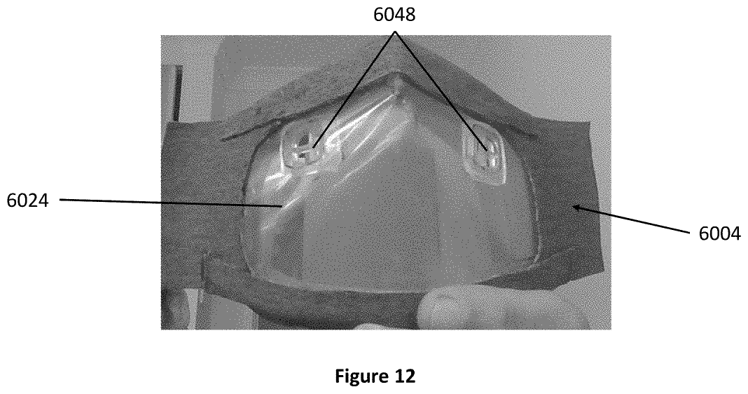

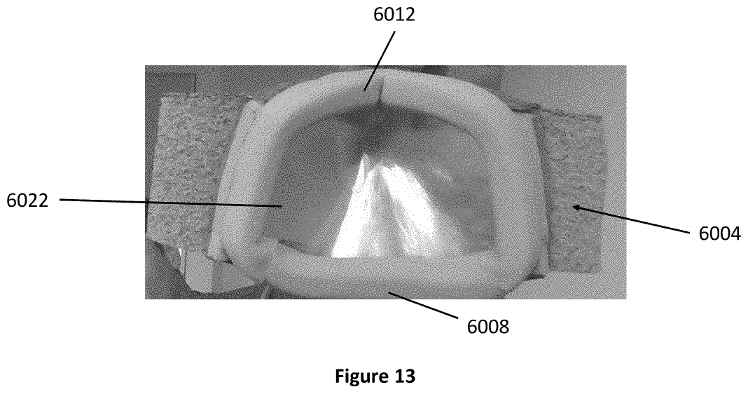

FIGS. 12 and 13 illustrate an example of a further embodiment of the disclosure wherein the outer shell structure 6024 includes air valves 6048. In some forms, the one-way air valves 6048 may be made from silicone and may allow for fresh air inhalation while also being sealed for sound attenuation when the user talks. In some forms, the air valves may also function with an anti-asphyxia valve (AAV) safety feature to allow the user to breathe in fresh air from their surroundings, rather than re-breathing the exhaled air that is built up in their mask. In some forms, the outer shell structure 6024 may be at least partially transparent and may be double glazed for aesthetic purposes. In some forms the valves 6024 are located along the upper surface of the outer shell structure 6024 of the mask. For example, transparency of the outer shell structure 6024 may allow others to view the user's facial expressions/non-verbal cues while conversing during a video call, which allows the listeners to know who is speaking.

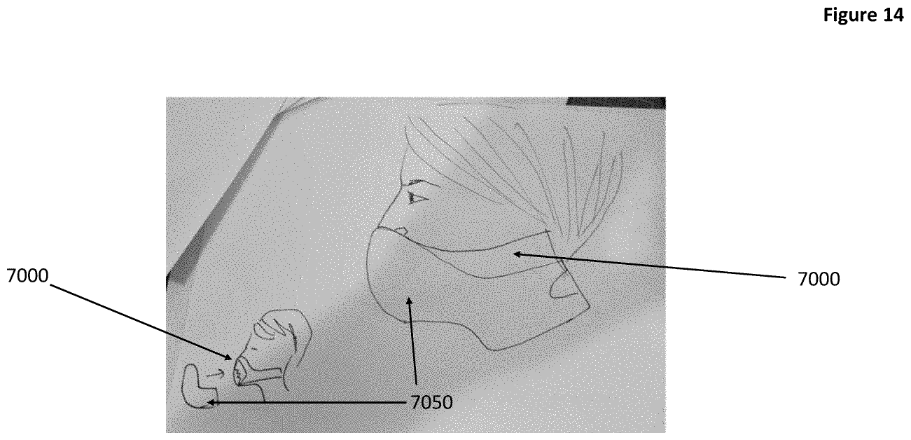

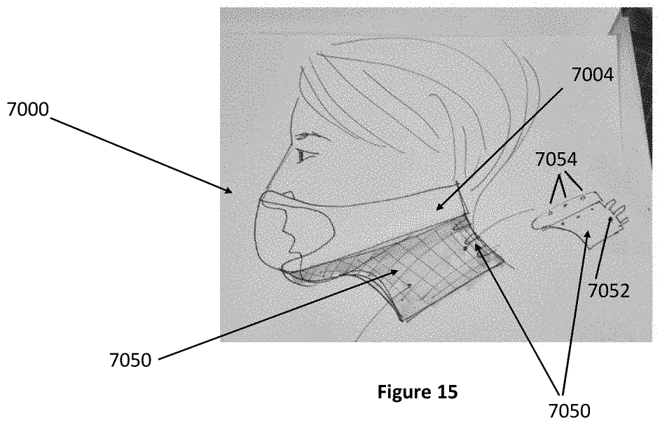

FIGS. 14 and 15 illustrate a further embodiment of the mask 7000 which in some forms includes a face cover or face covering structure 7050. The face covering structure may comprise a material scarf or wrap around to connect with or cover the mask to provide additional privacy for the wearer. Referring now to FIG. 15, the face covering structure 7050 may be attached to the mask 7000 via an attachment mechanism 7050. In some forms, the attachment mechanism 7050 may include a button mechanism 7054 and/or a hook and loop fastener mechanism (i.e. Velcro mechanism) 7052 to secure the face covering structure 7050 to the mask 7000. The face covering structure 7050 may be advantageous in assisting with attenuating the sound emitted from the user and/or their surroundings and it may provide a more discrete aesthetic.

Variations and modifications may be made to the parts previously described without departing from the spirit or ambit of the disclosure.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A mask for interfacing with a user's face to reduce audible noise in a user's surroundings resulting from a user's voice, the mask comprising:
a body configured to be positioned around a portion of the user's face, the body comprising:
an interfacing structure configured to interface with the user's face;
a sound attenuating structure.

2. A mask as defined in claim 1 wherein the mask is at least partially transparent to allow a line of sight from the outside to at least a portion of the user's face.

3. A mask as defined in claim 1, wherein the interfacing structure comprises a mouth interface configured to interface with the user's face around the user's mouth.

4. A mask as defined in claim 1, wherein the interfacing structure comprises a mouth interface and a nose interface, configured to interface with the user's face around the user's nose and mouth.

5. A mask as defined in claim 4, wherein the nose interface is configured to interface with at least a portion of the user's nares, inferior to the user's nasal ridge.

6. A mask as defined in claim 4, wherein the nose interface is configured to interface with at least a portion of the user's nasal ridge, superior to the user's nares.

7. A mask as defined in claim 1, wherein the interfacing structure forms a seal with the user's face.

8. A mask as defined in claim 1, wherein the body comprises an outer shell structure defining a three dimensional shaped chamber.

9. (canceled)

10. A mask as defined in claim 8 wherein the outer shell structure comprises an outer shell and an inner shell, wherein the outer shell is further from the user's face than the inner shell and wherein a vacuum cavity is located between the outer shell and the inner shell, the vacuum cavity being defined by a seal formed between the inner shell and outer shell.

11. (canceled)

12. A mask as defined in claim 10, wherein the inner shell of the outer shell structure interfaces with the sound attenuating structure

13. A mask as defined in claim 8, wherein the outer shell structure is formed from acrylic or an acrylic-like material.

14. A mask as defined in claim 8, wherein the outer shell structure comprises a valve that allows for air inhalation, exhalation and sound attenuation.

15. A mask as defined in claim 14, wherein the valve is made from silicone or a silicone-like material.

16. A mask as defined in claim 8, wherein the outer shell structure is at least partially transparent.

17. A mask as defined in claim 8, wherein at least a portion of the sound attenuating structure is positioned between the outer shell structure and the interfacing structure.

18. A mask as defined in claim 1, wherein the sound attenuating structure comprises an inner layer and outer layer, wherein at least a portion of the inner layer interfaces with the interfacing structure

19. A mask as defined in claim 1, wherein the sound attenuating structure reduces movement of sound into and out of the mask while allowing movement of air into and out of the mask.

20. A mask as defined in claim 16, wherein the outer layer of the sound attenuating structure acts as a controlled path to attenuate sound.

21. A mask as defined in claim 8, wherein the three-dimensional chamber of the body is defined by at least a portion of the interfacing structure and one or both the sound attenuating structure and the outer shell structure.

22. A mask as defined in claim 1, wherein the sound attenuating structure is integral with the interfacing structure.

23. (canceled)

24. (canceled)

25. (canceled)

26. (canceled)

27. A mask as defined in claim 1, wherein the sound attenuating structure comprises a ventilation structure, the ventilation structure comprising a fan mechanism and a filter structure.

28. (canceled)

29. (canceled)

30. A mask as defined in claim 1, wherein the sound attenuating structure is made from a foam-like material.

31. A mask as defined in claim 1, wherein the interfacing structure is made from a foam-like material.

32. (canceled)

33. (canceled)

34. A mask as defined in claim 8, wherein the outer shell structure made from a material that is non-rigid, pliable and/or flexible.
